(19) United States
(12) Patent Application Publication
(10) Pub. No.: US 2025/0035667 A1
(43) Pub. Date: Jan. 30, 2025

(54) Physical Quantity Sensor, Inertial Measurement Unit, And Electronic Apparatus

(71) Applicant: SEIKO EPSON CORPORATION, Tokyo (JP)

(72) Inventor: Tomokazu UMENO, Shiojiri (JP)

(21) Appl. No.: 18/785,049

(22) Filed: Jul. 26, 2024

(30) Foreign Application Priority Data
Jul. 27, 2023 (JP) 2023-122292

(51) Int. Cl. G01P 15/125; G01P 15/08

(52) U.S. Cl. CPC G01P 15/125; G01P 2015/0831; G01P 2015/0882

(57) ABSTRACT

A physical quantity sensor includes an element substrate, a movable body, and a fixed body. The movable body includes a suspender, a torsion spring coupled to the suspender, and a rotor that is coupled to the torsion spring and that includes a first electrode finger. The fixed body includes a stator bar that includes a second electrode finger. The rotor includes a longitudinal rotor bar extending in a Y-axial direction and a traversal rotor bar extending in an X-axial direction. The longitudinal rotor bar is provided with a slit.

The present application is based on, and claims priority from JP Application Serial Number 2023-122292, filed Jul. 27, 2023, the disclosure of which is hereby incorporated by reference herein in its entirety.

### BACKGROUND

### 1. Technical Field

The present disclosure relates to a physical quantity sensor, an inertial measurement unit with such a physical quantity sensor, and an electronic apparatus with such an inertial measurement unit.

### 2. Related Art

JP-A-2019-23613 discloses an example of physical quantity sensors that incorporate techniques about microelectromechanical systems (MEMS). More specifically, this patent document discloses a capacitive microelectromechanical accelerometer that includes: a substrate that defines a substrate plane expanding in a traversal and longitudinal directions; a first sensor that measures acceleration in a direction along a vertical axis perpendicular to the substrate plane; and an accelerometer package that contains an inner package plane adjacent to and parallel to the substrate plane positioned above and/or below the substrate. Further, the first sensor includes: a rotor that is movable relative to the substrate; a rotor hanger; and one or more stators that are immobile relative to the substrate. This rotor includes: a traversal rotor bar; a first longitudinal rotor bar attached to the traversal rotor bar; a second longitudinal rotor bar attached to the traversal rotor bar; and one or more rotor electrodes via which differential capacity is to be measured.

In a physical quantity sensor, as described above, a traversal rotor bar, a first longitudinal rotor bar, and a second longitudinal rotor bar typically have narrow shapes, which are disadvantageously vulnerable to shocks.

### SUMMARY

According to a first aspect of the present disclosure, a physical quantity sensor includes: a support substrate having a first fixture and a second fixture; a lid disposed so as to face the support substrate; and an element substrate mounted between the support substrate and the lid. The element substrate includes a fixed body joined to the support substrate and a movable body joined to the support substrate so as to be movable relative to the fixed body. The movable body includes a suspender joined to the first fixture, a support spring coupled to the suspender, and a rotor coupled to the support spring, the rotor including a first comb-tooth electrode. The fixed body includes a seating joined to the second fixture, the seating including a second comb-tooth electrode facing the first comb-tooth electrode. The rotor further includes a first joint extending in a first direction and a second joint extending in a second direction, the second direction intersecting the first direction. The first joint is provided with a first slit.

According to a second aspect of the present disclosure, an inertial measurement unit includes the physical quantity sensor described above.

According to a third aspect of the present disclosure, an electronic apparatus includes the inertial measurement unit described above.

### BRIEF DESCRIPTION OF THE DRAWINGS

FIG. 1 is a plan view of a physical quantity sensor according to a first embodiment of the present disclosure.

FIG. 2 is a cross-sectional view of the physical quantity sensor taken along line II-II in FIG. 1.

FIG. 3 is a cross-sectional view of the physical quantity sensor taken along line III-III in FIG. 1.

FIG. 4 is an enlarged plan view of region IV in FIG. 1.

FIG. 5 is an enlarged plan view of region V in FIG. 1.

FIG. 6A is a partly enlarged plan view of a physical quantity sensor according to a comparative example.

FIG. 6B is another partly enlarged plan view of a physical quantity sensor according to the comparative example.

FIG. 7A is a partly enlarged plan view of a physical quantity sensor according to modification 1 of the first embodiment.

FIG. 7B is a partly enlarged plan view of a physical quantity sensor according to modification 2 of the first embodiment.

FIG. 7C is a partly enlarged plan view of a physical quantity sensor according to modification 3 of the first embodiment.

FIG. 7D is a partly enlarged plan view of a physical quantity sensor according to modification 4 of the first embodiment.

FIG. 8 is an exploded perspective view of a schematic configuration of an inertial measurement unit according to a second embodiment of the present disclosure.

FIG. 9 is a perspective view of the circuit substrate on which the physical quantity sensor is mounted.

FIG. 10 is a perspective view of an electronic apparatus according to a third embodiment of the present disclosure.

FIG. 11 is a perspective view of an electronic apparatus according to a third embodiment of the present disclosure.

### DESCRIPTION OF EMBODIMENTS

Some embodiments of the present disclosure will be described below with reference to the accompanying drawings. It should be noted that some of the drawings illustrate components in different scales for better understanding. In addition, each drawing illustrates three mutually orthogonal axes, namely, an X-, Y-, and Z-axes. The arrow on each of the axes indicates a positive (+) direction, whereas the direction opposite to the positive direction is a negative (−) direction. Hereinafter, the direction parallel to the X-axis is defined as the X-axial direction; the direction parallel to the Y-axis is defined as the Y-axial direction; and the direction parallel to the Z-axis is defined as the Z-axial directions. A view as seen from the Z-axial direction is defined as a plan view, whereas a cross-sectional view along the Z-axis as seen from the X-axial direction is defined as a cross-sectional view.

The description “a component is disposed above a substrate” means that a component is disposed directly on a substrate, a component is disposed on a substrate with another component therebetween, a portion of a component is disposed directly on a substrate, or a portion of a component is disposed on a substrate with another component therebetween. The description “the upper surface of a component” means the +Z-side surface of a component. For example, the description “the upper surface of a substrate” means the +Z-side surface of a substrate. The description “the lower surface of a component” means the −Z-side surface of a component. For example, the description “the lower surface of a substrate” means the −Z-side surface of a substrate.

### 1. First Embodiment

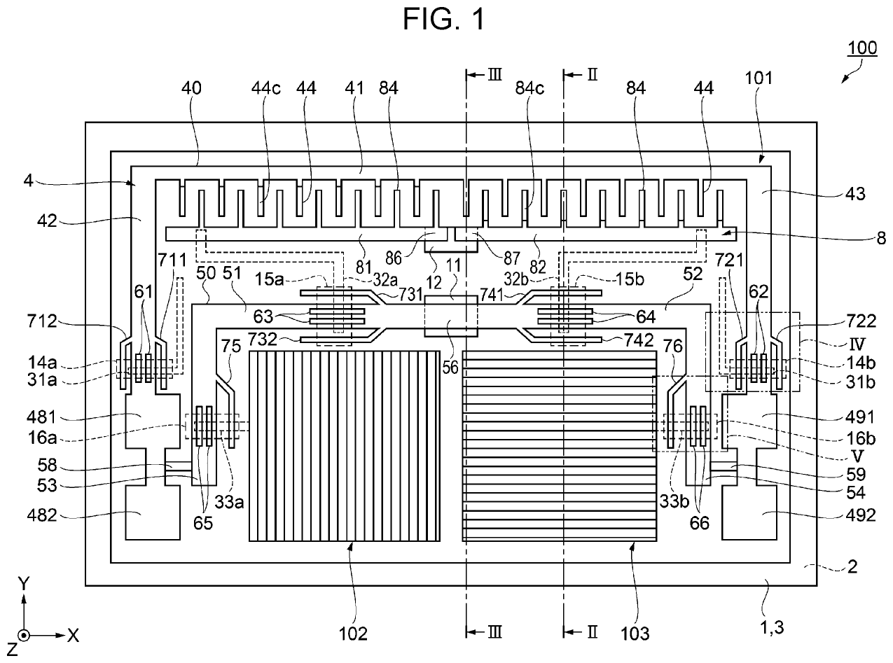

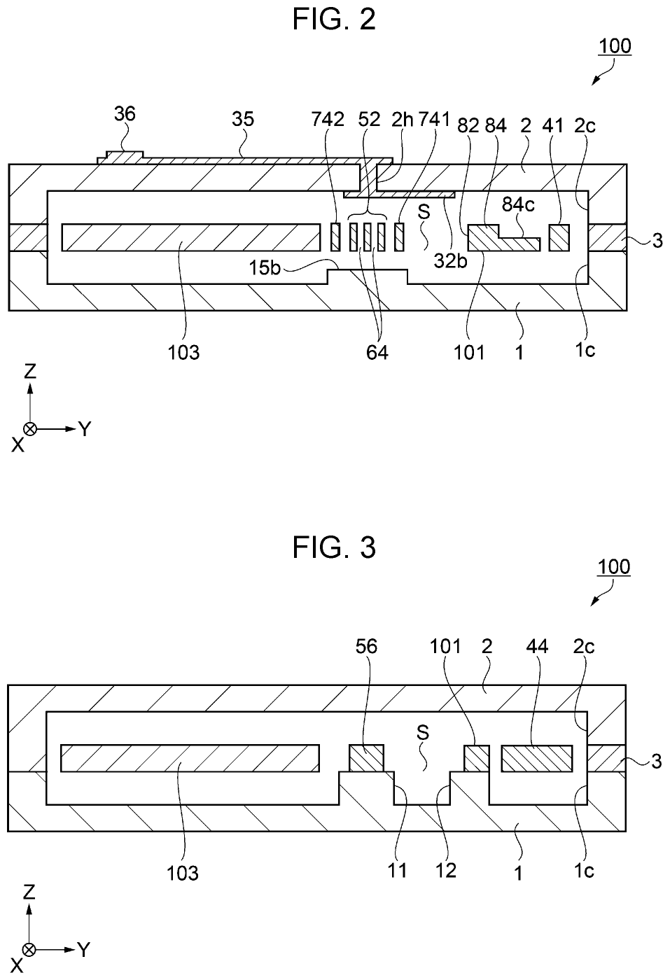

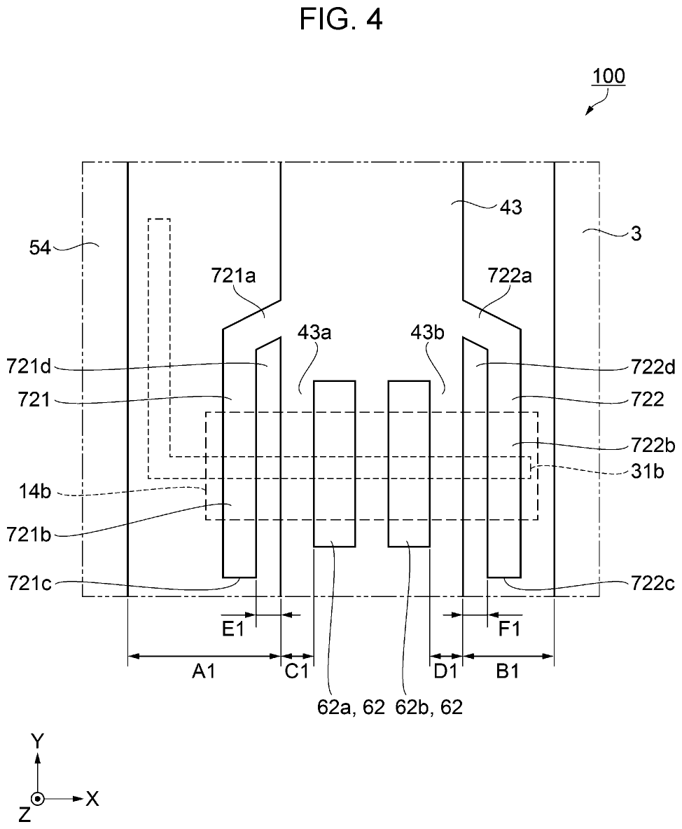

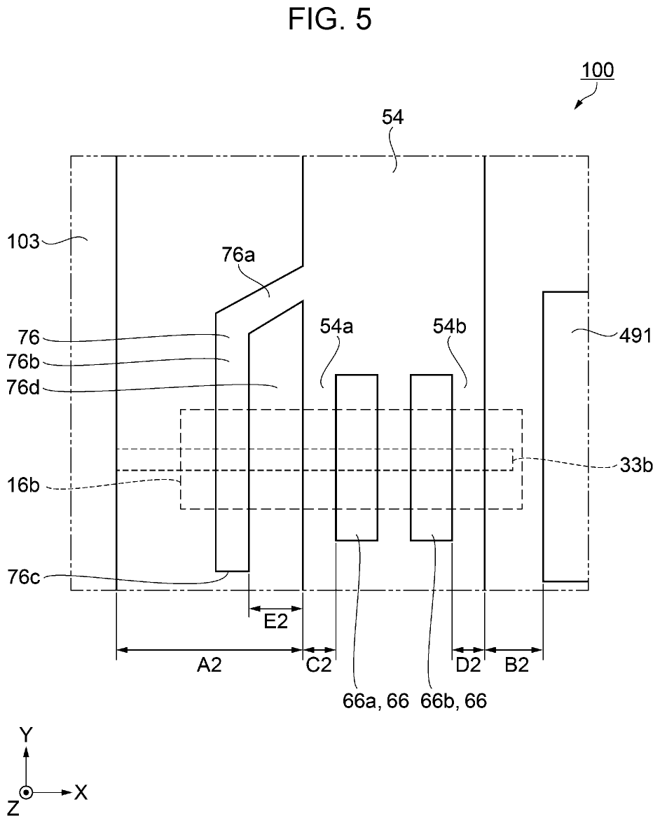

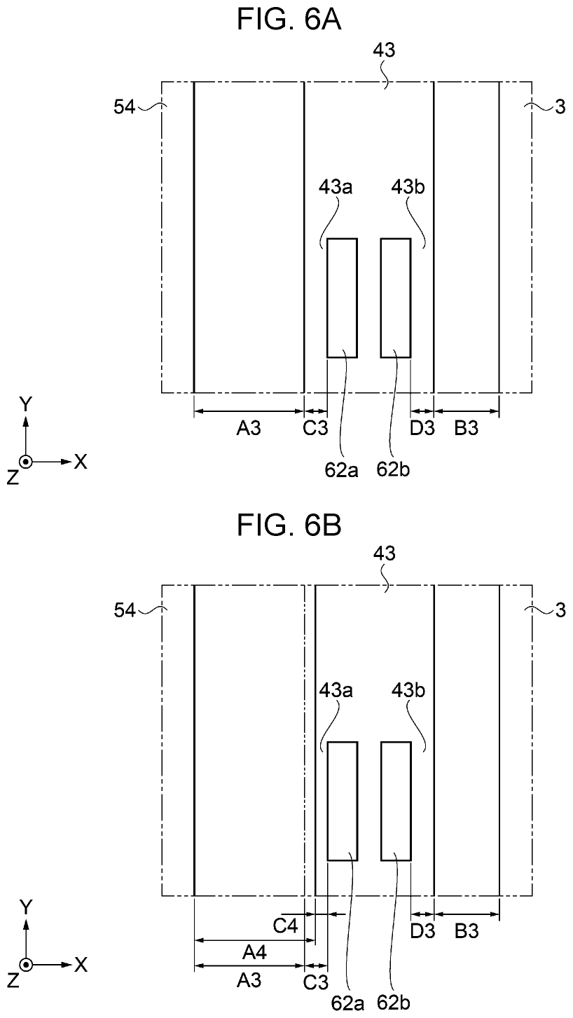

A description will be given below of a schematic configuration of a physical quantity sensor 100 according to a first embodiment of the present disclosure, with reference to the FIGS. 1 to 5. FIG. 1 is a plan view of the physical quantity sensor 100; FIG. 2 is a cross-sectional view of the physical quantity sensor 100 taken along line II-II in FIG. 1; FIG. 3 is a cross-sectional view of the physical quantity sensor 100 taken along line III-III in FIG. 1; FIG. 4 is an enlarged plan view of region IV in FIG. 1; and FIG. 5 is an enlarged plan view of region V in FIG. 1. It should be noted that a lid 2 is illustrated in FIG. 1 as a transparent component, for better understanding.

The physical quantity sensor 100 includes a support substrate 1, the lid 2, and an element substrate 3. The physical quantity sensor 100 is a MEMS device in which three sensor elements 101, 102, and 103 are mounted on the element substrate 3. Herein, a physical quantity sensor may also be referred to as an inertial sensor.

### 1.1. Support Substrate

As illustrated in FIGS. 1 to 3, the support substrate 1 includes: a cavity 1c, which is a recess formed in the upper surface thereof; and anchors 11 and 12 and protrusions 14a, 14b, 15a, 15b, 16a, and 16b all of which are formed inside the cavity 1c. Each of the anchors 11 and 12 and the protrusions 14a, 14b, 15a, 15b, 16a, and 16b protrudes from the upper surface in the Z-axial direction.

The anchor 11 is joined to a movable body 4 (described later) of the sensor element 101, whereas the anchor 12 is joined to a fixed body 8 (described later) of the sensor element 101. A joining method employed in this case is not limited to a specific one, but may be one selected as appropriate from such known joining methods as adhesive joining, anodic bonding, room-temperature bonding, direct bonding, and siloxane bonding. In this embodiment, the anchor 11 is an example of a first fixture, and the anchor 12 is an example of a second fixture.

Each of the protrusions 14a, 14b, 15a, 15b, 16a, and 16b is positioned so as to overlap a rotor 40 (described later) of the movable body 4 in plan view. More specifically, the protrusion 14a is positioned so as to overlap slits 61 in the rotor 40 in plan view. The protrusion 14b is positioned so as to overlap slits 62 in the rotor 40 in plan view. The protrusion 15a is positioned so as to overlap slits 63 in the rotor 40 in plan view. The protrusion 15b is positioned so as to overlap slits 64 in the rotor 40 in plan view. The protrusion 16a is positioned so as to overlap slits 65 in the rotor 40 in plan view. The protrusion 16b is positioned so as to overlap slits 66 in the rotor 40 in plan view.

Each of the protrusions 14a, 14b, 15a, 15b, 16a, and 16b functions as a stopper that, when the rotor 40 is warped by a shock, receives the rotor 40 so as not to be further warped.

In this embodiment, the support substrate 1 may be formed of a silicon substrate. In this case, the silicon substrate may be patterned to form the support substrate 1 with the cavity 1c. Alternatively, the support substrate 1 may be formed of a glass substrate, a ceramic substrate, or a silicon-on-insulator (SOI) substrate.

### 1.2. Lid

The lid 2 includes: a cavity 2c, which is a recess formed on the lower surface thereof; and wirelines 31a, 31b, 32a, 32b, 33a, and 33b disposed inside the cavity 2c. In this embodiment, the lid 2 may be formed of a silicon substrate. In this case, the silicon substrate is patterned to form the lid 2 with the cavity 2c. Alternatively, the lid 2 may be formed of a glass substrate.

Each of the wirelines 31a, 31b, 32a, 32b, 33a, and 33b is electrically coupled to respective external wirelines 35 disposed on an upper surface of the lid 2 via through-holes 2h disposed in the lid 2. Each of the external wirelines 35 has an electrode pad 36.

As illustrated in FIG. 1, each of the wirelines 31a, 31b, 32a, 32b, 33a, and 33b has a portion positioned so as to overlap the rotor 40 (described later) of the movable body 4 in plan view. More specifically, the wireline 31a has a portion positioned so as to overlap, in plan view, the slits 61, a first structure 711, and a second structure 712, all of which are disposed in the rotor 40. The wireline 31b has a portion positioned so as to overlap, in plan view, the slits 62, a first structure 721, and a second structure 722, all of which are disposed in the rotor 40. The wireline 32a has a portion positioned so as to overlap, in plan view, the slits 63, a first structure 731, and a second structure 732, all of which are disposed in the rotor 40. The wireline 32b has a portion positioned so as to overlap, in plan view, the slits 64, a first structure 741, and a second structure 742, all of which are disposed in the rotor 40. The wireline 33a has a portion positioned so as to overlap, in plan view, the slits 65 and a structure 75, all of which are disposed in the rotor 40. The wireline 33b has a portion positioned so as to overlap, in plan view, the slits 66 and a structure 76, all of which are disposed in the rotor 40. As illustrated in FIG. 2, the through-hole 2h via which the wireline 32b is coupled to the corresponding external wireline 35 is positioned immediately above the slits 64; however, the through-hole 2h does not necessarily have to be positioned immediately above the slits 64. In addition, the other through-holes 2h (not illustrated), via which the wirelines 31a, 31b, 32a, 33a, and 33b are coupled to the corresponding external wirelines 35, may be formed in the same manner.

### 1.3. Element Substrate

As illustrated in FIGS. 2 and 3, the element substrate 3 is disposed between the support substrate 1 and the lid 2. As illustrated in FIG. 1, the element substrate 3 is provided with the sensor elements 101, 102, and 103 mounted thereon.

The element substrate 3 may be formed of a silicon substrate to which impurities such as phosphorus (P) and boron (B) have been doped. In this case, the silicon substrate is patterned to form the element substrate 3 with the sensor elements 101, 102, and 103.

The sensor element 101 is an acceleration sensor that detects acceleration in the Z-axial direction; the sensor element 102 is an acceleration sensor that detects acceleration in the X-axial direction; and the sensor element 103 is an acceleration sensor that detects acceleration in the Y-axial direction. In this embodiment, the physical quantity sensor 100 is a triaxial acceleration sensor that detects acceleration in the three axial directions. Alternatively, the physical quantity sensor 100 may be an uniaxial acceleration sensor with the sensor element 101 alone or a biaxial acceleration sensor with the sensor element 101 and either the sensor element 102 or the sensor element 103.

As illustrated in FIGS. 2 and 3, both the sensor elements 101 and 103 are disposed inside a storage space S, which is defined by the cavities 1c and 2c. Likewise, the sensor element 102 is disposed inside the storage space S. The storage space S may be filled with an inert gas, such as nitrogen, helium, or argon, and maintained at substantially atmospheric pressure at an operating temperature.

As illustrated in FIG. 1, the sensor element 101 is provided with both the movable body 4 and the fixed body 8. The movable body 4 is disposed so as to be displaceable relative to the fixed body 8 for the purpose of detecting acceleration in the Z-axial direction. In other words, the movable body 4 varies a location thereof relative to the fixed body 8, depending on the acceleration applied thereto.

### 1.3.1. Movable Body

The movable body 4 includes the rotor 40, a suspender 50, a first torsion spring 58, and a second torsion spring 59.

The rotor 40 is hung on the suspender 50 with a first torsion spring 58 and a second torsion spring 59 therebetween. The suspender 50 may also be referred to as the hanging section or the hanger. In this embodiment, the first torsion spring 58 and the second torsion spring 59 are an example of a support spring.

The suspender 50 is joined to the anchor 11 of the support substrate 1 at an anchor point 56 so that the suspender 50 is fixed to the support substrate 1. Each of the first torsion spring 58 and the second torsion spring 59 is disposed on a rotational axis of the rotor 40, thereby functioning as a rotational shaft of the rotor 40. The rotor 40 is thus rotatably hung on the suspender 50 with both the first torsion spring 58 and the second torsion spring 59 therebetween. The rotor 40 may also be referred to as the seesaw because of the movement thereof.

### 1.3.1.1. Rotor

The rotor 40 includes: a first longitudinal rotor bar 42 and a second longitudinal rotor bar 43 each of which extends in the Y-axial direction; a traversal rotor bar 41 that extends in the X-axial direction; and a plurality of electrode fingers 44 each of which is disposed on the traversal rotor bar 41 and via which differential capacity is to be measured. The plurality of electrode fingers 44 are arranged in a comb fashion. Some of the plurality of electrode fingers 44 have recesses 44c.

In this embodiment, the first longitudinal rotor bar 42 and the second longitudinal rotor bar 43 are an example of a first joint; the traversal rotor bar 41 is an example of a second joint; and the electrode fingers 44 are an example of a first comb-tooth electrode.

The first longitudinal rotor bar 42 is provided with the slits 61, the first structure 711, and the second structure 712, whereas the second longitudinal rotor bar 43 is provided with the slits 62, the first structure 721, and the second structure 722. In this embodiment, the slits 61 and 62 are an example of a first slit.

As illustrated in FIG. 4, each slit 62 is a feedthrough channel that extends in the Y-axial direction and is formed across the second longitudinal rotor bar 43 in the Z-axial direction. Each of the first structure 721 and the second structure 722 is disposed in parallel with the slits 62 so as to extend in the Y-axial direction. The slits 61, the first structure 711, and the second structure 712, which are positioned line-symmetrically, respectively, to the slits 62, the first structure 721, and the second structure 722, have substantially the same configurations as the slits 62, the first structure 721, and the second structure 722. Therefore, details of the slits 61, the first structure 711, and the second structure 712 will not be described herein.

In this embodiment, the second longitudinal rotor bar 43 is provided with the two slits 62, or slits 62a and 62b, arranged side by side in the X-axial direction; however, there are no limitations on the number of slits 62 formed therein. Alternatively, the second longitudinal rotor bar 43 is provided with one or three or more slits.

As described above, each of the first structure 721 and the second structure 722 is disposed in parallel with the slits 62 (slits 62a and 62b) so as to extend in the Y-axial direction. The first structure 721 has an extension 721b disposed in parallel with the slit 62a so as to extend in the Y-axial direction. The extension 721b has two ends: an end 721a is coupled to the second longitudinal rotor bar 43 while being angled with respect to the second longitudinal rotor bar 43; and an end 721c is a free end. In this case, between the first structure 721 and the second longitudinal rotor bar 43, a feedthrough channel 721d having one open side is formed.

The second structure 722 has an extension 722b disposed in parallel with the slit 62b so as to extend in the Y-axial direction. The extension 722b has an end 722a and an end 722c: the end 722a is coupled to the second longitudinal rotor bar 43 while being angled with respect to the second longitudinal rotor bar 43; the end 722c is a free end. In this case, between the second structure 722 and the second longitudinal rotor bar 43, a feedthrough channel 722d having one open side is formed.

Each of the first structure 721 and the second structure 722 functions as a buffer section that, when the second longitudinal rotor bar 43 is displaced by an shock, for example, comes into contact with a surrounding structure earlier than the second longitudinal rotor bar 43, thereby dampening the shock applied to the second longitudinal rotor bar 43.

By providing the first structure 721 and the second structure 722 in parallel with the slits 62, the second longitudinal rotor bar 43, especially patterns 43a and 43b thereon, which are narrow portions resulting from the forming of the slits 62, can be protected from shocks. Each of the patterns 43a and 43b is a portion that has been left on the second longitudinal rotor bar 43 after the forming of the slits 62 and may also be referred to as the remaining pattern accordingly.

In a case where a width of the feedthrough channel 721d is denoted by E1 and a width of the feedthrough channel 722d is denoted by F1, it is necessary to form the feedthrough channel 721d and the feedthrough channel 722d in such a way that the widths E1 and F1 equate with each other (E1=F1). More specifically, when a width A1 is more than a width B1 (A1>B1) or when the width A1 is less than the width B1 (A1<B1), by equally setting the widths E1 and F1 (E1=F1), the second longitudinal rotor bar 43 with the slits 62 can easily be formed by an etching process such that widths C1 and D1 equate with each other (C1=D1). The reason for this will be described later in detail in the section of the comparative study by comparing structures with and without both the first structure 721 and the second structure 722.

In the above description, the width A1 corresponds to a distance between the second longitudinal rotor bar 43 and a second longitudinal hanger bar 54 (described later) of the suspender 50. The width B1 corresponds to a distance between the second longitudinal rotor bar 43 and the element substrate 3. The width C1 corresponds to a length of the pattern 43a on the second longitudinal rotor bar 43 between the slit 62a and the feedthrough channel 721d. The width D1 corresponds to a length of the pattern 43b on the second longitudinal rotor bar 43 between the slit 62b and the feedthrough channel 722d. The width E1 corresponds to a width of the feedthrough channel 721d, namely, a distance between the first structure 721 and the second longitudinal rotor bar 43. The width F1 corresponds to a width of the feedthrough channel 722d, namely, a distance between the second structure 722 and the second longitudinal rotor bar 43.

If the widths C1 and D1 do not equate with each other (C1≠D1), sensitivities on the axes other than the Z-axis may excessively increase so that precision of the sensor element 101 might be lowered. In this embodiment, however, by equally setting the widths E1 and F1 (E1=F1), the widths C1 and D1 can easily be equated with each other. It is thereby possible to provide the sensor element 101 with great precision.

In this embodiment, of the first structure 721, the end 721a is coupled to the second longitudinal rotor bar 43, and the end 721c is a free end. However, the first structure 721 may have an opposite configuration. More specifically, the end 721c may be coupled to the second longitudinal rotor bar 43, whereas the end 721a may be an open end. This configuration may also be applied to the second structure 722. An open end of the first structure 721 is expected to produce a higher buffer section effect. Thus, if one of both ends of the first structure 721 which is closer to the electrode fingers 44 is formed as an open end, the buffer section effect of the first structure 721 can be made more significant because the end of the first structure 721 closer to the electrode fingers 44 is more likely to be displaced than the other end thereof.

Each of the slits 62, the first structure 721, and the second structure 722 is positioned so as to overlap the protrusion 14b in plan view. In this configuration, an area of the second longitudinal rotor bar 43 around the slits 62 is more flexible than the other area. Thus, when the second longitudinal rotor bar 43 receives a strong shock, only the area of the second longitudinal rotor bar 43 around the slits 62 is typically brought into contact with the protrusion 14b. This configuration successfully makes the risk of damaging the second longitudinal rotor bar 43 lower than a configuration in which the other area is brought into contact with the protrusion 14b. Moreover, both the first structure 721 and the second structure 722 act to dampen the shock applied to the protrusion 14b upon the contact, thereby increasing resistance to shocks.

Each of the slits 62, the first structure 721, and the second structure 722 is also positioned so as to overlap the wireline 31b in plan view. Since only a small area of the second longitudinal rotor bar 43 faces the wireline 31b, parasitic capacitance generated between the second longitudinal rotor bar 43 and the wireline 31b becomes low. This configuration does not considerably affect performance, such as sensitivity, of the physical quantity sensor 100.

In this embodiment, each of the slits 62, the first structure 721, and the second structure 722 is positioned so as to overlap both the protrusion 14b and the wireline 31b in plan view. However, each of the slits 62, the first structure 721, and the second structure 722 does not necessarily have to be positioned so as to overlap at least one of the protrusion 14b and the wireline 31b in plan view. In other words, each of the slits 62, the first structure 721, and the second structure 722 may be positioned outside one of the protrusion 14b and the wireline 31b in plan view.

As illustrated in FIG. 1, the first longitudinal rotor bar 42 has damping plates 481 and 482. The damping plate 481 is disposed on the first longitudinal rotor bar 42 at a location closer to the +Y-side of the first torsion spring 58, whereas the damping plate 482 is disposed on the first longitudinal rotor bar 42 at a location closer to the −Y-side of the first torsion spring 58.

Likewise, the second longitudinal rotor bar 43 has damping plates 491 and 492. The damping plate 491 is disposed on the second longitudinal rotor bar 43 at a location closer to the +Y-side of the second torsion spring 59, whereas the damping plate 492 is disposed on the second longitudinal rotor bar 43 at a location closer to the −Y-side of the second torsion spring 59. Each of the damping plates 481, 482, 491, and 492 has a functions of reducing the displacement of the rotor 40.

### 1.3.1.2. Suspender

The suspender 50 includes: a first traversal hanger bar 51 and a second traversal hanger bar 52 each of which extends in the X-axial direction; and a first longitudinal hanger bar 53 and the second longitudinal hanger bar 54 each of which extends in the Y-axial direction. In this embodiment, the first traversal hanger bar 51 and the second traversal hanger bar 52 are an example of a third joint, and the first longitudinal hanger bar 53 and the second longitudinal hanger bar 54 are an example of a fourth joint.

Each of the first traversal hanger bar 51 and the second traversal hanger bar 52 is joined at an end to the anchor 11 at the anchor point 56, so that both the first traversal hanger bar 51 and the second traversal hanger bar 52 are fixed to the support substrate 1. The other end of the first traversal hanger bar 51 is coupled to an end of the first longitudinal hanger bar 53, which is coupled at the other end to the first torsion spring 58. The other end of the second traversal hanger bar 52 is coupled to an end of the second longitudinal hanger bar 54, which is coupled at the other end to the second torsion spring 59.

The first traversal hanger bar 51 is provided with the slits 63, the first structure 731, and the second structure 732. In this embodiment, the slits 63 are an example of a second slit. Each of the slits 63 is a feedthrough channel that extends in the X-axial direction and is formed across the first traversal hanger bar 51 in the Z-axial direction.

Each of the first structure 731 and the second structure 732 is disposed in parallel with the slits 63 so as to extend in the X-axial direction. One of both ends of the first structure 731 which is closer to the anchor point 56 is coupled to the first traversal hanger bar 51 while angled with respect to the first traversal hanger bar 51, whereas the other end thereof, which is closer to the first torsion spring 58, is a free end. Likewise, one of both ends of the second structure 732 which is closer to the anchor point 56 is coupled to the first traversal hanger bar 51 while angled with respect to the first traversal hanger bar 51, whereas the other end thereof, which is closer to the first torsion spring 58, is a free end. The open end (free end) of the first structure 731 is expected to produce a higher buffer section effect. Thus, if one of both ends of the first structure 731 which is closer to the first torsion spring 58 is formed as an open end, the buffer section effect of the first structure 731 can be made more significant because the end of the first structure 731 closer to the first torsion spring 58 is more likely to be displaced more than the other end thereof. Likewise, the open end (free end) of the second structure 732 is expected to produce a higher buffer section effect. Thus, if one of both ends of the second structure 732 which is closer to the first torsion spring 58 is formed as an open end, the buffer section effect of the second structure 732 can be made more significant because the end of the second structure 732 closer to the first torsion spring 58 is more likely to be displaced more than the other end thereof. Alternatively, one of both ends of the first structure 731 which is closer to the anchor point 56 may be open, whereas the other ends thereof, which is closer to the first torsion spring 58, may be coupled to the first traversal hanger bar 51. Likewise, one of both ends of the second structure 732 which is closer to the anchor point 56 may be open, whereas the other ends thereof, which is closer to the first torsion spring 58, may be coupled to the first traversal hanger bar 51.

The second traversal hanger bar 52 is provided with the slits 64, the first structure 741, and the second structure 742. In this embodiment, the slits 64 are an example of a second slit. Each of the slits 64 is a feedthrough channel that extends in the X-axial direction and is formed across the second traversal hanger bar 52 in the Z-axial direction. Each of the first structure 741 and the second structure 742 is disposed in parallel with the slits 64 so as to extend in the X-axial direction. One of both ends of the first structure 741 which is closer to the anchor point 56 is coupled to the second traversal hanger bar 52 while being angled with respect to the second traversal hanger bar 52, whereas the other end thereof, which is closer to the second torsion spring 59, is open. Likewise, one of both ends of the second structure 742 which is closer to the anchor point 56 is coupled to the second traversal hanger bar 52 while being angled with respect to the second traversal hanger bar 52, whereas the other end thereof, which is closer to the second torsion spring 59, is open.

Similar to the first structure 721 and the second structure 722 described above, each of the first structures 731 and 741 and the second structures 732 and 742 functions as a buffer section. Similar to the configurations of the first structure 721 and the second structure 722 described above, the feedthrough channels between the first structure 731 and the first traversal hanger bar 51 and between the second structure 732 and the first traversal hanger bar 51 have substantially the same width. Likewise, similar to the first structure 721 and the second structure 722 described above, the feedthrough channels between the first structure 741 and the second traversal hanger bar 52 and between the second structure 742 and the second traversal hanger bar 52 have substantially the same width.

Each of the slits 63, the first structure 731, and the second structure 732 is positioned so as to overlap the protrusion 15a in plan view. In addition, each of the slits 63, the first structure 731, and the second structure 732 is positioned so as to overlap the wireline 32a in plan view.

As described above, each of the slits 63, the first structure 731, and the second structure 732 is positioned so as to overlap both the protrusion 15a and the wireline 32a in plan view. However, each of the slits 63, the first structure 731, and the second structure 732 only has to be positioned so as to overlap at least one of the protrusion 15a and the wireline 32a in plan view. In other words, each of the slits 63, the first structure 731, and the second structure 732 may be positioned outside one of the protrusion 15a and the wireline 32a in plan view.

Each of the slits 64, the first structure 741, and the second structure 742 is positioned so as to overlap the protrusion 15b in plan view. In addition, each of the slits 64, the first structure 741, and the second structure 742 is positioned so as to overlap the wireline 32b in plan view. As described above, each of the slits 64, the first structure 741, and the second structure 742 is positioned so as to overlap both the protrusion 15b and the wireline 32b in plan view. However, each of the slits 64, the first structure 741, and the second structure 742 only has to be positioned so as to overlap at least one of the protrusion 15b and the wireline 32b in plan view. In other words, each of the slits 64, the first structure 741, and the second structure 742 may be positioned outside one of the protrusion 15b and the wireline 32b in plan view.

The first longitudinal hanger bar 53 is provided with the slits 65 and the structure 75, whereas the second longitudinal hanger bar 54 is provided with the slits 66 and the structure 76. In this embodiment, the slits 65 and 66 are an example of a third slit.

As illustrated in FIG. 5, each slit 66 is a feedthrough channel that extends in the Y-axial direction and is formed across the second longitudinal hanger bar 54 in the Z-axial direction. In addition, the structure 76 is disposed in parallel with the slits 66 so as to extend in the Y-axial direction. As described above, a single structure may be disposed in parallel with the slits 66. The slits 65 and the structure 75, which are positioned line-symmetrically, respectively, to the slits 66 and the structure 76, have substantially the same configurations as the slits 66 and the structure 76. Therefore, details of the slits 65 and the structure 75 will not be described herein.

In this embodiment, the second longitudinal hanger bar 54 is provided with the two slits 66, or slits 66a and 66b, arranged side by side in the X-axial direction. However, there are no limitations on the number of slits 66 formed therein; alternatively, the second longitudinal hanger bar 54 may be provided with one or three or more slits.

The structure 76 is disposed in parallel with the slit 66a so as to extend in the Y-axial direction. The structure 76 has an extension 76b disposed in parallel with the slit 66a so as to extend in the Y-axial direction. The extension 76b has two ends: an end 76a is coupled to the second longitudinal hanger bar 54 while angled with respect to the second longitudinal hanger bar 54; and an end 76c is an open end. In this case, between the structure 76 and the second longitudinal hanger bar 54, a feedthrough channel 76d having one open side is formed. Similar to the first structure 721 and the second structure 722 described above, the structure 76 functions as a buffer section.

In a case where a width of the feedthrough channel 76d is denoted by E2 and a distance between the second longitudinal hanger bar 54 and the damping plate 491 is denoted by B2, it is necessary to form the feedthrough channel 76d and the second longitudinal hanger bar 54 in such a way that the widths E2 and B2 equate with each other (E2=B2). More specifically, when a width A2 is more than the width B2 (A2>B2), by equally setting the widths E2 and B2 (E2=B2), the second longitudinal hanger bar 54 with the slits 66 can easily be formed by an etching process such that widths C2 and D2 equate with each other (C2=D2). The reason for this will be described later in detail in the section of the comparative study.

The width A2 corresponds to a distance between the second longitudinal hanger bar 54 and the sensor element 103; a width C2 corresponds to a length of a pattern 54a on the second longitudinal hanger bar 54 between the slit 66a and the feedthrough channel 76d; and a width D2 corresponds to a width of a pattern 54b on the second longitudinal hanger bar 54 which is disposed on the +X-side of the slit 66b.

If the widths C2 and D2 do not equate with each other (C2≠D2), the sensitivities on the axes other than the Z-axis may excessively increase so that the precision of the sensor element 101 might be lowered. In this embodiment, by equally setting the widths E2 and B2 (E2=B2), the widths C2 and D2 can easily be equated with each other (C2=D2). It is thereby possible to provide the sensor element 101 with great precision.

Each of the slits 66 and the structure 76 is positioned so as to overlap the protrusion 16b in plan view. In this configuration, an area of the second longitudinal hanger bar 54 around the slits 66 is more flexible than the other area. Thus, when the second longitudinal hanger bar 54 receives a strong shock, only the area of the second longitudinal hanger bar 54 around the slits 66 is typically brought into contact with the protrusion 16b. This configuration successfully makes the risk of damaging the second longitudinal hanger bar 54 lower than a configuration in which the other area is brought into contact with the protrusion 16b. Moreover, the structure 76 act to dampen the shock applied to the protrusion 16b upon the contact, thereby increasing resistance to shocks.

Each of the slits 66 and the structure 76 is also positioned so as to overlap the wireline 33b in plan view. Since only a small area of the second longitudinal hanger bar 54 faces the wireline 33b, parasitic capacitance generated between the second longitudinal hanger bar 54 and the wireline 33b becomes low. This configuration does not considerably affect the performance, such as sensitivity, of the physical quantity sensor 100.

In this embodiment, as described above, each of the slits 66 and the structure 76 is positioned so as to overlap both the protrusion 16b and the wireline 33b in plan view. However, each of the slits 66 and the structure 76 only has to be positioned so as to overlap at least one of the protrusion 16b and the wireline 33b in plan view. In other words, each of the slits 66 and the structure 76 may be positioned outside one of the protrusion 16b and the wireline 33b in plan view.

### 1.3.2. Fixed Body

As illustrated in FIG. 1, the fixed body 8 includes: a first stator bar 81; a second stator bar 82; and a plurality of electrode fingers 84 arranged on each of the first stator bar 81 and the second stator bar 82. The electrode fingers 84 are used to measure differential capacity.

The plurality of electrode fingers 84 are arranged in a comb fashion. Each of the electrode fingers 84 is disposed between adjacent ones of the electrode fingers 44 so as to face the adjacent electrode fingers 44. The electrode fingers 84 disposed in the second stator bar 82 have respective recesses 84c. In this embodiment, the first stator bar 81 and the second stator bar 82 are an example of a seating, and the electrode fingers 84 are an example of a second comb-tooth electrode.

When the sensor element 101 receives acceleration in the Z-axial direction, the rotor 40 rotates around both the first torsion spring 58 and the second torsion spring 59. This movement is detected based on a variation in differential capacity between the electrode fingers 84 and the electrode fingers 44.

The first stator bar 81 is joined to the anchor 12 of the support substrate 1 at an anchor point 86, so that the first stator bar 81 is fixed to the support substrate 1. Likewise, the second stator bar 82 is joined to the anchor 12 of the support substrate 1 at an anchor point 87, so that the second stator bar 82 is fixed to the support substrate 1.

### 1.3.3. Comparative Study

Next, a description will be given below of a reason why the equal setting of the widths E1 and F1 (E1=F1) makes it easy to equate the width C1 and the width D1 with each other (C1=D1). In this embodiment, the first structure 721 and the second structure 722 are provided for equally setting the widths E1 and F1 (E1=F1). Thus, a comparative example in which the first structure 721 and the second structure 722 are not provided will be described below.

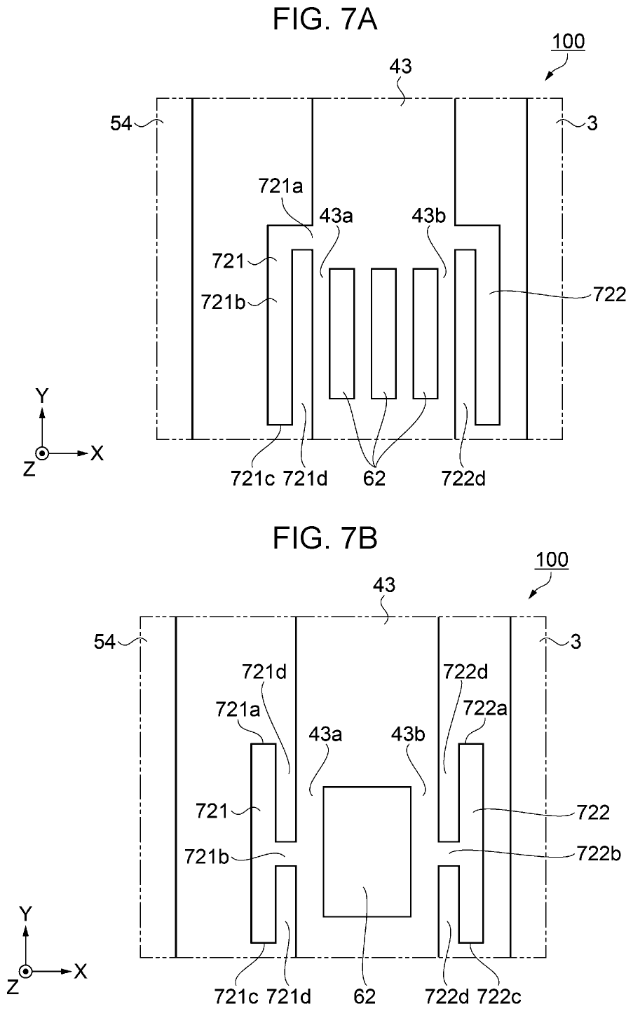

FIGS. 6A and 6B, which correspond to FIG. 4, are each a partly enlarged plan view of a physical quantity sensor 100 according to a comparative example. More specifically, FIG. 6A illustrates an ideal configuration of the sensor element 101 based on a design thereof, whereas FIG. 6B illustrates an actual configuration of the sensor element 101.

As illustrated in FIG. 6A, when an element substrate 3 is etched to form a second longitudinal rotor bar 43 with slits 62a and 62b, a width C3 of a pattern 43a and a width D3 of a pattern 43b equate with each other in accordance with a design of the physical quantity sensor 100 (C3=D3). A reason for equally setting the widths C3 and D3 is to lower sensitivities on the axes other than the Z-axis, thereby providing a sensor element 101 with great precision.

If a width A3 is larger than a width B3 (A3>B3), however, a rate at which a portion with the width A3 is etched is typically higher than a rate at which a portion with the width B3 is etched, due to the micro-loading effect. In this case, a resultant width of the pattern 43a may equate a width C4, which is smaller than the width C3 (C4<C3), as illustrated in FIG. 6B.

Each of the widths A3 and A4 corresponds to a distance between the second longitudinal rotor bar 43 and a second longitudinal hanger bar 54. The width B3 corresponds to a distance between the second longitudinal rotor bar 43 and the element substrate 3. Each of the widths C3 and C4 corresponds to a width of the pattern 43a of the second longitudinal rotor bar 43. The width D3 corresponds to a width of the pattern 43b of the second longitudinal rotor bar 43.

Unlike the comparative example, in this embodiment, the first structure 721 and the second structure 722 are disposed in parallel with the slits 62, as illustrated in FIG. 4, to equate the width E1 of the feedthrough channel 721d with the width F1 of the feedthrough channel 722d (E1=F1).

When the element substrate 3 is etched to form the second longitudinal rotor bar 43 with the slits 62, the first structure 721, and the second structure 722, the difference in etching rate which is caused by the micro-loading effect is controlled, so that the widths C1 and D1 can be equally set with ease (C1=D1). Consequently, it is possible to provide a highly precise sensor element 101 with low sensitivities on the axes other than the Z-axis.

In this embodiment, the structure 76 is disposed in parallel with the slits 66, as illustrated in FIG. 5. In addition, the width E2 of the feedthrough channel 76d disposed close to the slits 66 is equated with the width B2 corresponding to the distance between the second longitudinal hanger bar 54 and the damping plate 491 (E2=B2).

When the element substrate 3 is etched to form the second longitudinal hanger bar 54 with the slits 66, the structure 76, and the damping plate 491, the difference in etching rate which is caused by the micro-loading effect is controlled, so that the widths C2 and D2 can be equally set with ease (C2=D2). Consequently, it is possible to provide a highly precise sensor element 101 with low sensitivities on the axes other than the Z-axis. Providing a single structure 76 in this manner can also control the difference in etching rate caused by the micro-loading effect.

### 1.3.4. Modifications

The embodiment of the first structure 721 and the second structure 722 described above may be modified in various ways. Some specific modifications of the embodiment of the first structure 721 and the second structure 722 will be described below. It should be noted that such modifications are also applicable to the first structure 711, 731, and 741, the second structure 712, 732, and 742, and the structures 75 and 76.

### 1.3.4.1. Modification 1

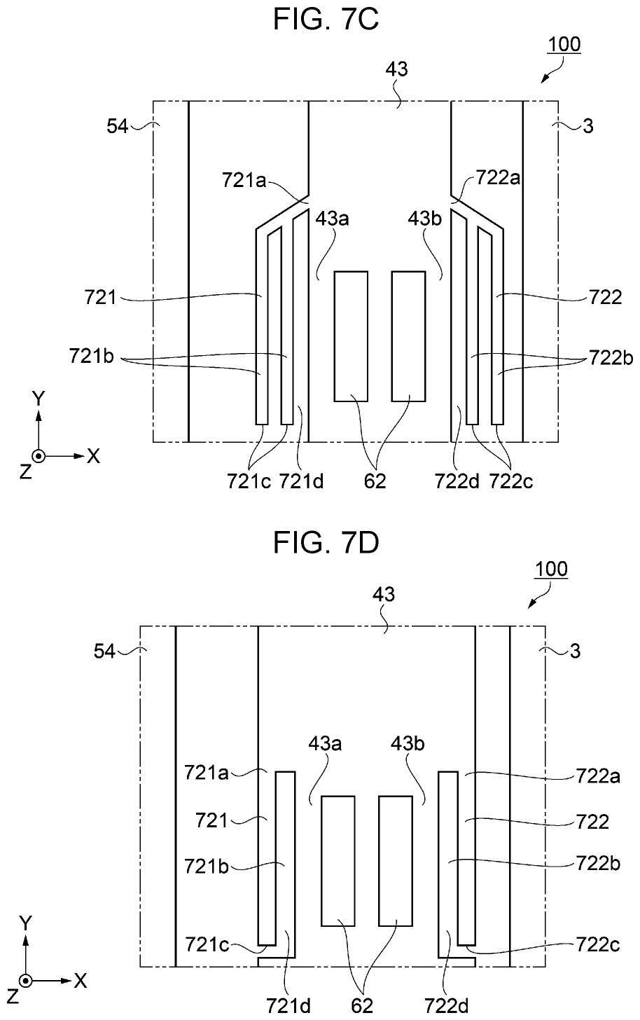

FIG. 7A, which corresponds to FIG. 4, is a partly enlarged plan view of a physical quantity sensor 100 according to modification 1 of the foregoing first embodiment. In modification 1, the physical quantity sensor 100 includes: a second longitudinal rotor bar 43; and a first structure 721 having an extension 721b with a right-angle portion, an end 721a vertical to the second longitudinal rotor bar 43 and coupled thereto, and an end 721c that is an open end; and a second structure 722 having the same configuration as the first structure 721.

The second longitudinal rotor bar 43 has three slits 62. A feedthrough channel 721d is disposed between the second longitudinal rotor bar 43 and the first structure 721 each of which is disposed in parallel with the slits 62. A feedthrough channel 722d is disposed between the second longitudinal rotor bar 43 and the second structure 722. Further, the feedthrough channel 721d and the feedthrough channel 722d have substantially the same width. In this case, a pattern 43a and a pattern 43b, which are portions with the slits 62, have substantially the same width.

### 1.3.4.2. Modification 2

FIG. 7B, which corresponds to FIG. 4, is a partly enlarged plan view of a physical quantity sensor 100 according to modification 2 of the foregoing first embodiment. In modification 2, the physical quantity sensor 100 includes a second longitudinal rotor bar 43 having a first structure 721, which includes: an extension 721b coupled at a center to the second longitudinal rotor bar 43; and an end 721a and an end 721c each of which is an open end. With the ends 721a and 721c formed as open ends, the first structure 721 produces a better buffer section effect. In this case, the physical quantity sensor 100 further includes a second structure 722 having the same configuration as the first structure 721.

The second longitudinal rotor bar 43 has a single slit 62. Two feedthrough channels 721d are disposed between the second longitudinal rotor bar 43 and the first structure 721 disposed in parallel with the slit 62. Likewise, two feedthrough channels 722d are disposed between the second longitudinal rotor bar 43 and the second structure 722. In this case, each feedthrough channel 721d and each feedthrough channel 722d are formed so as to have substantially the same width. As a result, a pattern 43a and a pattern 43b, which are portions with the slit 62, have substantially the same width.

### 1.3.4.3. Modification 3

FIG. 7C, which corresponds to FIG. 4, is a partly enlarged plan view of a physical quantity sensor 100 according to modification 3 of the foregoing first embodiment. In modification 3, the physical quantity sensor 100 includes a second longitudinal rotor bar 43 and a first structure 721 with two extensions 721b. The extensions 721b share an end 721a that is coupled to the second longitudinal rotor bar 43 and angled with respect to the second longitudinal rotor bar 43 and have respective ends 721c each of which is a free end. With the two extensions 721b, the first structure 721 produces a better buffer section effect. It should be noted that the first structure 721 may have three or more extensions 721b. Moreover, the physical quantity sensor 100 includes a second structure 722 having the same configuration as the first structure 721.

The second longitudinal rotor bar 43 has two slits 62. A feedthrough channel 721d is disposed between the second longitudinal rotor bar 43 and the first structure 721 disposed in parallel with the slits 62. Likewise, a feedthrough channel 722d is disposed between the second longitudinal rotor bar 43 and the second structure 722. In this case, the feedthrough channel 721d and the feedthrough channel 722d are formed so as to have substantially the same width. As a result, a pattern 43a and a pattern 43b, which are portions with the slits 62, have substantially the same width.

### 1.3.4.4. Modification 4

FIG. 7D, which corresponds to FIG. 4, is a partly enlarged plan view of a physical quantity sensor 100 according to modification 4 of the foregoing first embodiment. In modification 4, the physical quantity sensor 100 includes: a second longitudinal rotor bar 43; and a first structure 721 disposed within a width of the second longitudinal rotor bar 43. In other words, the first structure 721 has no portions protruding from the second longitudinal rotor bar 43. Moreover, the physical quantity sensor 100 includes a second structure 722 having the same configuration as the first structure 721.

The second longitudinal rotor bar 43 has two slits 62. A feedthrough channel 721d is disposed between the second longitudinal rotor bar 43 and the first structure 721 disposed in parallel with the slits 62. Likewise, a feedthrough channel 722d is disposed between the second longitudinal rotor bar 43 and the second structure 722. Further, the feedthrough channel 721d and the feedthrough channel 722d have substantially the same width. In this case, a pattern 43a and a pattern 43b, which are portions with the slits 62, have substantially the same width.

### 1.4. Functions and Effects

As described above, a physical quantity sensor 100 according to this embodiment has functions and effects that will be described above. The physical quantity sensor 100 includes: a support substrate 1 having an anchor 11 (first fixture) and an anchor 12 (second fixture); a lid 2 disposed so as to face the support substrate 1; and an element substrate 3 mounted between the support substrate 1 and the lid 2. The element substrate 3 includes a fixed body 8 joined to the support substrate 1 and a movable body 4 joined to the support substrate 1 so as to be movable relative to the fixed body 8. The movable body 4 includes a suspender 50 joined to the anchor 11, a second torsion spring 59 (support spring) coupled to the suspender 50, and a rotor 40 coupled to the second torsion spring 59, the rotor 40 including an electrode finger 44 (first comb-tooth electrode). The fixed body 8 includes a second stator bar 82 (seating) joined to the anchor 12, the second stator bar 82 including an electrode finger 84 (second comb-tooth electrode) facing the electrode finger 44. The rotor 40 further includes a second longitudinal rotor bar 43 (first joint) extending in a Y-axial direction (first direction) and a traversal rotor bar 41 (second joint) extending in a X-axial direction (second direction), the +X-axial direction intersecting the Y-axial direction. The second longitudinal rotor bar 43 is provided with a slit 62 (first slit).

By providing the slit 62 in the second longitudinal rotor bar 43, as described above, the second longitudinal rotor bar 43 is made more flexible and can withstand a stronger shock accordingly. Consequently, it is possible to provide a highly reliable physical quantity sensor 100.

In the physical quantity sensor 100 according to this embodiment, the rotor 40 may further include a first structure 721 disposed in parallel with the slit 62 so as to extend in the Y-axial direction.

Since the first structure 721 may function as a buffer section, the second longitudinal rotor bar 43 may be able to withstand a further stronger shock.

In the physical quantity sensor 100 according to this embodiment, the first structure 721 may have an end 721a (first end) and an end 721c (second end), the end 721a being coupled to the second longitudinal rotor bar 43, the end 721c being a free end.

Since the first structure 721 is a free end, as described above, the second longitudinal rotor bar 43 may be able to withstand a further stronger shock.

In the physical quantity sensor 100 according to this embodiment, the rotor 40 may further include a second structure 722 disposed in parallel with the slit 62 so as to extend in the Y-axial direction. The first structure 721 and the second structure 722 may be arranged on both sides of the second longitudinal rotor bar 43 with the slit 62 therebetween.

As described above, the first structure 721 and the second structure 722, each of which functions as a buffer section, may be arranged on both sides of the second longitudinal rotor bar 43. This arrangement may enable the second longitudinal rotor bar 43 to withstand a further stronger shock.

In the physical quantity sensor 100 according to this embodiment, a distance (width E1) between the first structure 721 and the second longitudinal rotor bar 43 may equate with a distance (width F1) between the second structure 722 and the second longitudinal rotor bar 43.

By equally setting the widths E1 and F1 (E1=F1), a width C1 of a pattern 43a on the second longitudinal rotor bar 43 may be equated with a width D1 of a pattern 43b on the second longitudinal rotor bar 43. Consequently, it may be possible to provide a highly precise sensor element 101 with low sensitivities on axes other than a detection axis.

The physical quantity sensor 100 according to this embodiment may further include a protrusion 14b disposed on the support substrate 1 so as to overlap the slit 62 in plan view.

When the second longitudinal rotor bar 43 is largely displaced by a shock, for example, only an area of the second longitudinal rotor bar 43 around the slit 62 may be brought into contact with the protrusion 14b. Since the area of the second longitudinal rotor bar 43 around the slit 62 is more flexible than the other area, the second longitudinal rotor bar 43 may be able to withstand a further higher shock.

The physical quantity sensor 100 according to this embodiment may further include a wireline 31b disposed on the lid 2 so as to overlap the slit 62 in plan view.

Since only a small area of the second longitudinal rotor bar 43 faces the wireline 31b, parasitic capacitance between the second longitudinal rotor bar 43 and the wireline 31b may become low. Consequently, it may be possible to provide a sensor element 101 that is superior in terms of sensitivity and other sensor performances.

In the physical quantity sensor 100 according to this embodiment, the suspender 50 may include a second traversal hanger bar 52 (third joint) joined to the anchor 11, the second traversal hanger bar 52 extending in the X-axial direction, and a second longitudinal hanger bar 54 (fourth joint) coupled to the second traversal hanger bar 52, the second longitudinal hanger bar 54 extending in the Y-axial direction. The second traversal hanger bar 52 may be provided with a slit 64 (second slit).

By providing the slit 64 in the second traversal hanger bar 52, the second traversal hanger bar 52 may be made more flexible and may be able to withstand a stronger shock accordingly. Consequently, it may be possible to provide a highly reliable physical quantity sensor 100. In the physical quantity sensor 100 according to this embodiment, the second longitudinal hanger bar 54 may be provided with a slit 66 (third slit).

By providing the slit 66 in the second longitudinal hanger bar 54, the second longitudinal hanger bar 54 may be made more flexible and may be able to withstand a stronger shock accordingly. Consequently, it may be possible to provide a highly reliable physical quantity sensor 100.

### 2. Second Embodiment

### 2.1. Outline of Inertial Measurement Unit

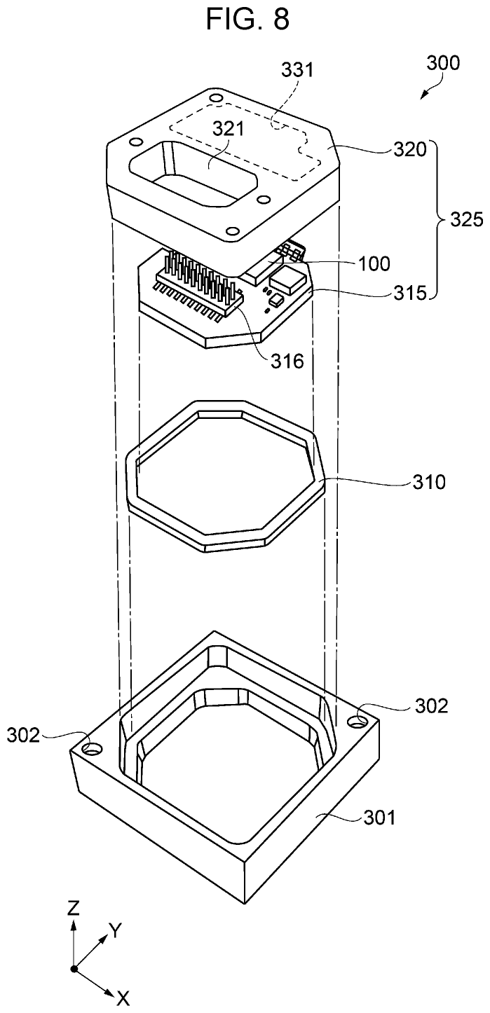

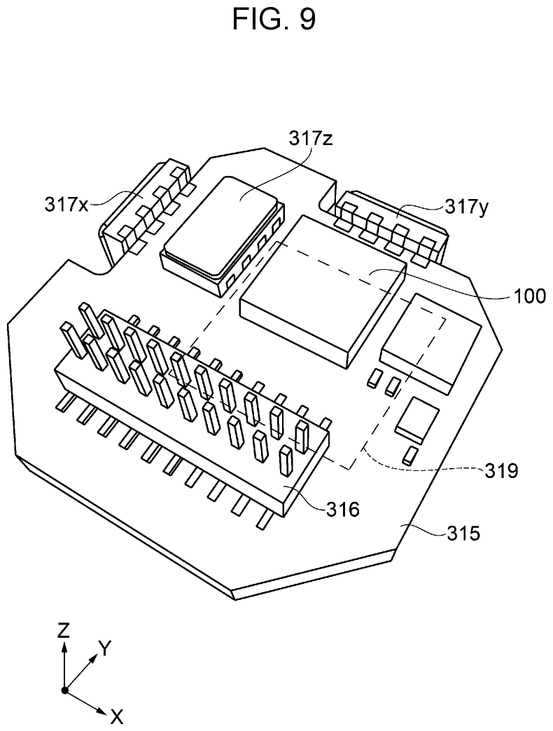

Next, a description will be given below of an inertial measurement unit (IMU) 300, according to a second embodiment of the present disclosure, with reference to FIGS. 8 and 9. The inertial measurement unit 300 includes the physical quantity sensor 100 described above. FIG. 8 is an exploded perspective view of a schematic configuration of the inertial measurement unit 300; FIG. 9 is a perspective view of the inertial measurement unit 300 equipped with a circuit substrate 315 on which the physical quantity sensor 100 is mounted.

The inertial measurement unit 300 is mountable in various types of mounting apparatuses, such as automobiles, robots, smartphones, and activity monitors and can measure an attitude, a behavior, and some other physical quantities of such a mounting apparatus.

As illustrated in FIG. 8, the inertial measurement unit 300 includes an outer case 301, a joining member 310, and a sensor module 325. The inertial measurement unit 300 can be assembled by fitting and inserting the sensor module 325 into the outer case 301 with the joining member 310 therebetween.

The outer case 301 is a rectangular and lidless container, which has a plurality of walls surrounding and defining an inner space. The outer case 301 may be made of a metal such as aluminum, zinc, or stainless steel, a resin, or a composite material of a metal and a resin.

The outer case 301 is provided with two feed holes 302 in an upper surface thereof at respective diagonally opposite corners. The feed holes 302 are used to attach the inertial measurement unit 300 to the mounting apparatus. The sensor module 325 includes an inner case 320 and the circuit substrate 315.

The inner case 320 is a member that supports the circuit substrate 315 and is shaped such that the inner case 320 can be mounted into the outer case 301. The inner case 320 may be made of the same material as the outer case 301. The inner case 320 includes: a lower surface provided with a recess 331 that suppresses the circuit substrate 315 from coming into contact with the lower surface; and an aperture 321 via which a connector 316 of the circuit substrate 315 is exposed to the outside.

With reference to FIG. 9, a description will be given below of a configuration of the circuit substrate 315 on which the physical quantity sensor 100 is mounted. The circuit substrate 315, which may be formed of a glass epoxy substrate, is a multilayer substrate in which a plurality of via-holes are formed. Alternatively, instead of a glass epoxy substrate, the circuit substrate 315 may be formed of a composite substrate or a rigid substrate such as a ceramic substrate.

The circuit substrate 315 includes the connector 316, the physical quantity sensor 100, an angular velocity sensor 317z mounted on an upper surface thereof, and angular velocity sensors 317x and 317y mounted on side surfaces thereof. The connector 316 is a plug-type connector having a plurality of connection pins arranged in two lines at equal intervals in the X-axial direction. In this embodiment, the connector 316 has ten connection pins for each line, namely, a total of twenty connection pins; however, the number of connection pins may be changed as appropriate based on a design specification.

The angular velocity sensor 317z is a gyro sensor that detects a uniaxial angular velocity in the Z-axial direction. More specifically, the angular velocity sensor 317z is a vibration gyro sensor with a crystal oscillator, which detects an angular velocity from a Coriolis force applied to a vibrating object. Alternatively, instead of a vibration gyro sensor, the angular velocity sensor 317z may be a sensor having a ceramic or silicon oscillator.

To detect a uniaxial angular velocity in the X-axial direction, the circuit substrate 315 is provided with the angular velocity sensor 317x mounted on a −X-side surface thereof with a mounting surface of the angular velocity sensor 317x being orthogonal to the X-axis. Likewise, to detect a uniaxial angular velocity in the Y-axial direction, the circuit substrate 315 is provided with the angular velocity sensor 317y mounted on a +Y-side surface thereof with a mounting surface of the angular velocity sensor 317y being orthogonal to the Y-axis. It should be noted that the angular velocity sensors 317x, 317y, and 317z may be implemented in a single package.

The physical quantity sensor 100 is a triaxial acceleration sensor that measures acceleration in the X-, Y-, and Z-axial directions; however, the physical quantity sensor 100 may be a uniaxial or biaxial acceleration sensor, as described above.

The circuit substrate 315 further includes, as a controller, a control IC 319 mounted on a lower surface thereof. The control IC 319, which is a microcontroller unit (MCU), houses: a storage section including nonvolatility memory; a communication interface (I/F); a digital-analog (A/D) converter; and some other components. The control IC 319 controls operations of respective components constituting the inertial measurement unit 300. The storage section stores a program that specifies a sequence and procedures for detecting acceleration and angular velocities, a program for converting analog detection data into digital data and incorporating the digital data into packet data, and other accessory data. The circuit substrate 315 may have some more electronic components mounted thereon.

With the physical quantity sensor 100 described above incorporated therein, the inertial measurement unit 300 can reliably withstand a strong shock.

As described above, with a physical quantity sensor 100 according to this embodiment incorporated therein, an inertial measurement unit 300 provides highly reliable measurements, in addition to producing the effects described in the first embodiment.

### 3. Third Embodiment

Next, a description will be given below of an electronic apparatus according to a third embodiment, which is equipped with the inertial measurement unit 300 according to the foregoing second embodiment. In the description, examples of the electronic apparatus are a movable body such as an automobile and a portable device such as a smartphone.

### 3.1. Outline of Movable Body

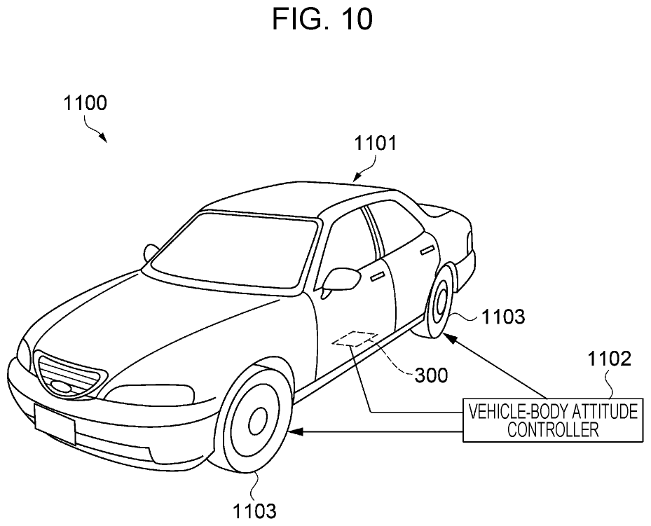

FIG. 10 is a perspective view of a movable body, which corresponds to an electronic apparatus according to the third embodiment. In this case, an automobile 1100 is an example of the movable body.

The automobile 1100 includes the inertial measurement unit 300 described above, which is equipped with the physical quantity sensor 100. The inertial measurement unit 300 detects an attitude of a vehicle body 1101 of the automobile 1100 and outputs detection signals, which include an angular velocity signal and an acceleration signal. The detection signals output from the inertial measurement unit 300 are supplied to a vehicle-body attitude controller 1102, which controls an attitude of the vehicle body 1101. Based on those detection signals, the vehicle-body attitude controller 1102 detects the attitude of the vehicle body 1101. In accordance with the detection result, the vehicle body 1101 controls stiffness/softness of suspensions and operations of brakes in respective wheels 1103.

The detection signals of the inertial measurement unit 300 may also be used for a keyless entry, an immobilizer, a car navigation system, a car air-conditioner, an antilock braking system (ABS), an airbag, a tire pressure monitoring system (TPMS), an engine controller, a control apparatus that employs inertial navigation for automatic operation, and an electronic control unit (ECU) in a battery power monitor and some other electric components in a hybrid automobile or an electric vehicle.

In addition to the automobile 1100, the inertial measurement unit 300 may be mounted in other movable bodies. For example, the inertial measurement unit 300 is mounted in a movable body such as a biped robot, an electric train, a radio-controlled airplane, a radio-controlled helicopter, a drone, an agricultural machine, and a construction machine. In this case, for example, the detection signals of the inertial measurement unit 300 can be used to control an attitude of the movable body or to measure a location thereof.

As in this embodiment, an inertial measurement unit 300 equipped with a physical quantity sensor 100, as described above, can be mounted in an automobile 1100 or another movable body. Therefore, the inertial measurement unit 300 according to this embodiment enables the reliable automobile 1100 to have better reliability.

### 3.2. Outline of Portable Device

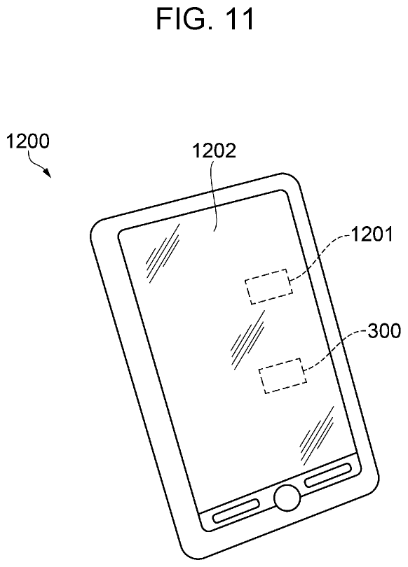

FIG. 11 is a perspective view of a portable device, which corresponds to an electronic apparatus according to the third embodiment of the present disclosure. In this case, a smartphone 1200 is an example of the portable device.

The smartphone 1200 includes the inertial measurement unit 300, described above, which is equipped with the physical quantity sensor 100. The inertial measurement unit 300 outputs detection signals to a control circuit 1201 in the smartphone 1200. Based on the detection signals, the control circuit 1201 can recognize an attitude and behavior of the smartphone 1200 and, in response to the recognized attitude and behavior, can change an image displayed on a display 1202, emit a warning sound or an effective sound, or drive a vibration motor so that the body of the smartphone 1200 vibrates.

In addition to the smartphone 1200, the inertial measurement unit 300 may be mounted in other portable devices. For example, the inertial measurement unit 300 is mounted in a portable device such as a smartwatch, an activity monitor, a head-mounted display (HMD), mobile personal computer (PC), a tablet PC, a camera, or a personal digital assistant (PDA). In this case, for example, the detection signals of the inertial measurement unit 300 can be used to recognize an attitude and behavior of the portable device. In response to the recognized attitude and behavior, the portable device can change a displayed image, emit a warning sound or an effective sound, or drive a vibration motor so that the main body vibrates.

As in this embodiment, an inertial measurement unit 300 equipped with a physical quantity sensor 100, as described above, can be mounted in a smartphone 1200 or another portable device. Therefore, the physical quantity sensor 100 according to this embodiment enables the smartphone 1200 to have better reliability.

As described above, an automobile 1100 and a smartphone 1200, which correspond to examples of an electronic apparatus according to the second and third embodiments, each include an inertial measurement unit 300. The inertial measurement unit 300 enables the automobile 1100 and the smartphone 1200 to have better reliability.

The embodiments of the present disclosure have been described; however, such embodiments are not intended to limit the present disclosure. The components described in the embodiments may be replaced with other similar functional components and may be used together with any other components.

What is claimed is:

1. A physical quantity sensor comprising:
a support substrate having a first fixture and a second fixture;
a lid disposed so as to face the support substrate; and
an element substrate mounted between the support substrate and the lid, wherein
the element substrate includes a fixed body joined to the support substrate and a movable body joined to the support substrate so as to be movable relative to the fixed body,
the movable body includes a suspender joined to the first fixture, a support spring coupled to the suspender, and a rotor coupled to the support spring, the rotor including a first comb-tooth electrode,
the fixed body includes a seating joined to the second fixture, the seating including a second comb-tooth electrode facing the first comb-tooth electrode, and
the rotor further includes a first joint extending in a first direction and a second joint extending in a second direction, the second direction intersecting the first direction, and
the first joint is provided with a first slit.

2. The physical quantity sensor according to claim 1, wherein
the rotor further includes a first structure disposed in parallel with the first slit so as to extend in the first direction.

3. The physical quantity sensor according to claim 2, wherein
the first structure has a first end and a second end, the first end being coupled to the first joint, the second end being a free end.

4. The physical quantity sensor according to claim 3, wherein
the rotor further includes a second structure disposed in parallel with the first slit so as to extend in the first direction, and
the first structure and the second structure are arranged on both sides of the first joint with the first slit therebetween.

5. The physical quantity sensor according to claim 4, wherein
a distance between the first structure and the first joint equates with a distance between the second structure and the first joint.

6. The physical quantity sensor according to claim 1, further comprising a protrusion disposed on the support substrate 1 so as to overlap the first slit in plan view.

7. The physical quantity sensor according to claim 1, further comprising a wireline disposed on the lid so as to overlap the first slit in plan view.

8. The physical quantity sensor according to claim 1, wherein
the suspender includes a third joint joined to the first fixture, the third joint extending in the second direction, and a fourth joint coupled to the third joint, the fourth joint extending in the first direction, and
the third joint is provided with a second slit.

9. The physical quantity sensor according to claim 8, wherein
the fourth joint is provided with a third slit.

10. An inertial measurement unit comprising the physical quantity sensor according to claim 1.

11. An electronic apparatus comprising the inertial measurement unit according to claim 10.
